(19) United States
(12) Patent Application Publication
(10) Pub. No.: US 2026/0311312 A1
(43) Pub. Date: Oct. 8, 2026

(54) EVALUATING BUILDINGS FOR MATERIAL VALUE AND RECOVERY USING CONTACTLESS SCANNING

(71) Applicant: AUTODESK, INC., San Francisco, CA (US)

(72) Inventors: Sophia Guarany CABRAL CASINO, Miami, FL (US); Peter Thomas STOREY, Utrecht (NL); Damon LAU, Staten Island, NY (US); Fopefoluwa BADEMOSI, Boston, MA (US); James DONNELLY, Birmingham (GB); John Henry LOCKE, New York, NY (US)

(21) Appl. No.: 19/538,776

(22) Filed: Feb. 12, 2026

Related U.S. Application Data
(60) Provisional application No. 63/761,834, filed on Feb. 21, 2025.

(51) Int. Cl. G06T 7/00; G06T 7/13; G06T 7/62

(52) U.S. Cl. CPC G06T 7/0002; G06T 7/13; G06T 7/62; G06T 2207/10024; G06T 2207/10048; G06T 2207/20081; G06T 2207/30184

(57) ABSTRACT

In various embodiments, a computer-implemented method for analyzing walls based on images of the walls to generate a digital representation of the walls includes receiving a plurality of images of a wall of a building interior, performing a damage assessment of the wall using a machine learning (ML) model based on the plurality of images, identifying a plurality of edges of the wall based on the plurality of images, identifying one or more elements within or behind the wall based on the plurality of images, generating a digital twin corresponding to the wall based on the damage assessment, the plurality of edges, and the one or more elements, and performing at least one action based on the digital twin.

### CROSS-REFERENCE TO RELATED APPLICATION

This application claims the priority benefit of U.S. Provisional Patent Application No. 63/761,834, entitled “TECHNIQUES FOR EVALUATING EXISTING BUILDINGS FOR MATERIAL VALUE AND ENHANCING RECOVERY USING CONTACTLESS MULTI-MODAL SCANNING AND MACHINE LEARNING,” filed Feb. 21, 2025, the contents of which are incorporated by reference herein in its entirety.

### BACKGROUND

### Field of the Various Embodiments

Embodiments of the present disclosure relate generally to computer science and complex software applications and, more specifically, to evaluating buildings for material value and recovery using contactless scanning.

### Description of the Related Art

The construction industry is responsible for a large portion of global carbon dioxide emissions and waste. A significant portion of emissions and waste stems from operational emissions associated with operating and maintaining buildings. However, another significant portion of such emissions stems from construction of new buildings, including emissions associated with building materials such as cement, steel, and aluminum. Additionally, other construction-related activities generate further emissions, including emissions related to fuel, electricity, and other construction-related activities. As a result, renovation and remodeling of existing structures constitute an increasing portion of construction-related activity relative to construction of new structures due to sustainability advantages. Reuse and/or recycling of a building or building materials is an approach that is increasingly utilized for sustainability purposes. In general, assessment of a building composition in terms of a building structure and construction materials used in a building is important for assessing reusability of materials in the building. A building material audit is an assessment of the materials used in a building or construction project that involves identifying, cataloging, and evaluating the materials used in a building or a construction project.

One drawback of reuse and/or recycling of buildings is a need to perform building material audits. Reuse of buildings and materials within buildings is often hindered by the complexity of building material audits. A building material audit often requires expensive, invasive, and sometimes destructive tests, site visits, and/or other procedures. In some cases, detailed information about a building is missing, particularly in the case of older structures. For example, to ascertain the materials used in a structural plan, walls or other structural elements may need to be scanned, removed, or damaged. Accordingly, a building material audit represents an expensive and time-consuming process that can burden reuse and/or recycling of a building or discourage such activity altogether.

As the foregoing illustrates, what is needed in the art are more effective techniques for performing building material audits.

### SUMMARY

In various embodiments, a computer-implemented method for analyzing walls based on images of the walls to generate a digital representation of the walls includes receiving a plurality of images of a wall of a building interior, performing a damage assessment of the wall using a machine learning (ML) model based on the plurality of images, identifying a plurality of edges of the wall based on the plurality of images, identifying one or more elements within or behind the wall based on the plurality of images, generating a digital twin corresponding to the wall based on the damage assessment, the plurality of edges, and the one or more elements, and performing at least one action based on the digital twin.

At least one technical advantage of the disclosed techniques relative to the prior art is that the disclosed techniques enable building material audits to be performed using contactless and non-destructive techniques that involve imaging devices such as a red/green/blue (RGB) imaging device and/or a thermal imaging device. Walls within an interior of a building can be imaged using an imaging device, and a composition of the materials used to construct the building can be assessed based on imagery captured from the interior of the building. Images captured by imaging devices can then be assessed using image processing techniques to determine the material composition of the structure of the building. Additionally, a location of elements used in the composition of the building can be used to streamline the process of removing and recycling material such as drywall or gypsum board, as well as structural elements, from the building. Therefore, a building material audit can be performed in a nondestructive and noninvasive manner, while also streamlining the process of material removal and recycling. The disclosed techniques also offer building designers data about material reuse that streamline existing building design.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments.

FIG. 2 is a more detailed illustration of the wall analysis application of FIG. 1, according to various embodiments.

FIG. 3 is a flow diagram of method steps for conducting a damage assessment by damage detection module, according to various embodiments.

FIG. 4 is a flow diagram illustrating how the RGB image processing module of FIG. 1 generates a polygon corresponding to the shape of a wall, according to various embodiments.

FIG. 5 is a flow diagram illustrating how the thermal image processing module of FIG. 1 identifies elements within or behind a wall, according to various embodiments.

FIG. 6 is a flow diagram illustrating how the digital twin generator of FIG. 1 identifies elements within or behind a wall, according to various embodiments.

FIG. 7 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

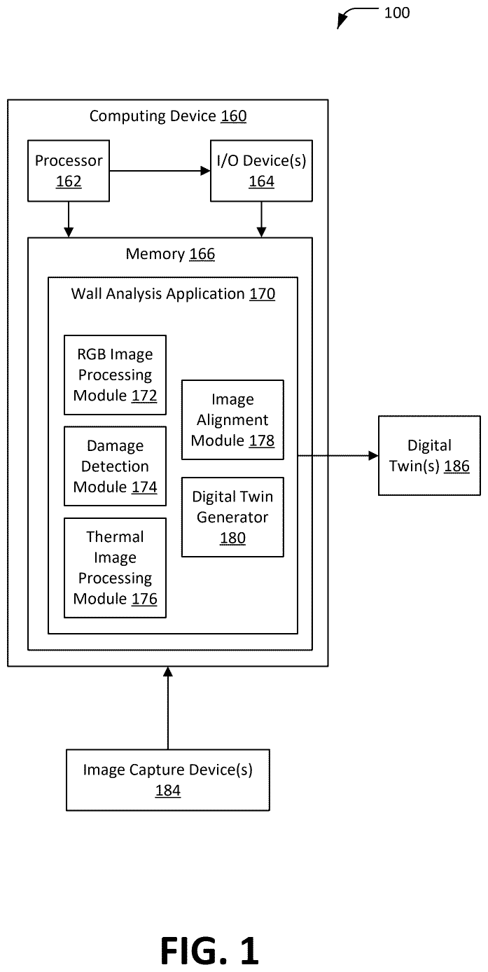

FIG. 1 is a conceptual illustration of a system 100 configured to implement one or more aspects of the various embodiments. As shown, in some embodiments, the system 100 includes, without limitation, a computing device 160 and one or more image capture devices 184. The computing device 160 includes, without limitation, a processor 162, one or more I/O devices 164, and a memory 166. The memory 166 includes, without limitation, a wall analysis application 170. The wall analysis application 170 includes, without limitation, a red-green-blue (RGB) image processing module 172, a damage detection module 174, a thermal image processing module 176, an image alignment module 178, and a digital twin generator 180. In some other embodiments, the system 100 can include or access any number and/or types of other client devices, server devices, remotely located ML models, or any combination thereof.

Any number of the components of the system 100 can be distributed across multiple geographic locations or implemented in one or more cloud computing environments (e.g., encapsulated shared resources, software, data) in any combination. In some embodiments, the computing device 160 and/or zero or more other server devices (not shown) can be implemented as one or more compute instances in a cloud computing environment, implemented as part of any other distributed computing environment, or implemented in a stand-alone fashion. In various embodiments, the computing device 160 can be integrated with any number and/or types of other devices (e.g., one or more other compute instances and/or a display device) into a user device. Some examples of user devices include, without limitation, desktop computers, laptops, smartphones, and tablets.

Computing device 160 includes a processor 162, I/O devices 164, and a memory 166, coupled together. Processor 162 includes any technically feasible set of hardware units configured to process data and execute software applications, such as one or more CPUs. I/O devices 164 include any technically feasible set of devices configured to perform input and/or output operations, such as, for example and without limitation, a display device, a keyboard, and/or a touchscreen, among others.

Memory 166 includes any technically feasible storage media configured to store data and software applications, such as, for example and without limitation, a hard disk, a RAM module, and/or a ROM. Memory 166 includes a wall analysis application 170. The wall analysis application 170 can include or represent separate portions of a distributed software entity that is configured to perform any and all of the various operations described herein.

Image capture devices 184 include, without limitation, one or more image capture devices configured to capture images of interior walls of a building. The image capture devices 184 can include a plurality of cameras that can be arranged in a camera rig so that all of the image capture devices 184 are oriented to point in the same or a similar direction to capture images of a wall from the same or similar angle and height. The image capture devices 184 can include, without limitation, an RGB camera configured to capture color images, a thermal camera configured to capture thermal imagery, and/or a light detection and ranging (LiDAR) camera. In some embodiments, the image capture devices 184 can include a greyscale camera, X-ray devices, or other types of imaging devices that can be aimed at a wall for image capture.

Wall analysis application 170 receives images of a wall from the image capture devices 184 and generates a digital twin 186 corresponding to the wall. The digital twin 186 can include a 3D model or another type of virtual representation of the wall. The wall analysis application 170 generates the digital twin 186 based on the images received from the image capture devices 184, as described herein. Wall analysis application 170 utilizes one or more image processing techniques to determine the edges of the wall and output a polygon representing the wall shape. Wall analysis application 170 also utilizes a machine learning (ML) model configured to perform a damage assessment of the wall based on the images from the image capture devices 184. Wall analysis application 170 further performs image processing techniques on thermal images from the image capture devices 184 to identify elements within or behind the wall.

Wall analysis application 170 includes, without limitation, an RGB image processing module 172. The RGB image processing module 172 performs an analysis of one or more RGB images of the wall to identify the wall shape. Other types of images can also be analyzed other than RGB images, such as greyscale images. In one embodiment, RGB image processing module 172 performs edge detection techniques or other computer vision or pixel processing techniques on an image of the wall to identify the outline or shape of the wall. In one embodiment, wall analysis application 170 performs geometric edge detection techniques, such as Canny edge detection, to identify the edges of the wall. Canny edge detection can be used to identify the edge of a wall to within a single pixel width. In some embodiments, a Hough transform can be performed to find the wall shape. In some embodiments, deep learning techniques can be utilized to identify the wall shape based on one or more RGB images from the image capture devices 184. For example, a deep neural network can be used to generate one or more edge maps. Additionally, a convolutional neural network (CNN) or U-Net can be utilized that label each pixel in an image as a portion of a building interior, such as “wall,” “floor”, “ceiling,” or “window,” and the labeled wall portions are extracted to form the wall shape.

RGB image processing module 172 generates a polygon representing a predicted wall shape. Accordingly, RGB image processing module 172 also performs a wall confirming step in which a user or an automated process confirms that the edges identified by RGB image processing module 172 correspond to the shape of the wall. In one embodiment, a user interface can be presented to the user that overlays the edges of the polygon onto an image of the wall and allows the user to confirm that the edges reflect the shape of the wall. The user interface allows the user to adjust or move the edges so that the edges align with the shape of the wall within the image. In some embodiments, an automated computer-vision process can confirm that the edges reflect the shape of the wall shown in the images from the image capture devices 184.

Damage detection module 174 performs a damage assessment of the wall based on an image, such as an RGB image, of the wall received from image capture devices 184. In one embodiment, damage detection module 174 executes a machine learning (ML) model that is trained to detect wall damage, such as cracks or water damage, in images of a wall. The ML model can comprise an object detection model that is trained using a training data set including labeled images in which water damage or cracks are labeled. Such labeled images serve as a ground-truth data set that is used to train the ML model to detect damage. The damage detection module 174 outputs an annotated image that identifies the location of cracks or water damage, if any. The annotated image also identifies the type of damage to the wall, if any damage is detected.

Thermal image processing module 176 processes one or more thermal images output from image capture devices 184 to identify elements of the wall that are within or behind the wall. Elements that are within or behind the wall can be associated with a different thermal signature than drywall or other material that comprises the bulk of the wall. For example, drywall screws that are within the wall, studs that are behind the wall, electrical fixtures or wiring that are within or behind the wall, or other elements of the wall can appear in a thermal image with varying levels of brightness, shapes, and contrast. Additionally, the one or more thermal images can indicate moisture content associated with the wall, and such moisture content can be used to identify possible water damage. Thermal image processing module 176 outputs an annotated image that identifies an inventory of items that are within or behind the wall along with respective locations of the items. In one embodiment, the thermal image processing module 176 receives multiple thermal images from a thermal camera, and the multiple thermal images are stitched together using an image stitching pipeline. The image stitching pipeline outputs a single thermal image of the wall from which the image alignment module 178 can generate the annotated image.

Image alignment module 178 processes the polygon and annotated images from the RGB image processing module 172, damage detection module 174, and thermal image processing module 176, respectively. Image alignment module 178 aligns the images based on the polygon output by RGB image processing module 172. In one embodiment, image alignment module 178 performs an alignment process in which RGB images and thermal images captured by image capture devices 184 are aligned using edge alignment and systematic minimization of lens distortion effects.

Digital twin generator 180 generates a digital twin 186 of the wall. The digital twin generator 180 generates the digital twin 186 based on the aligned RGB and thermal images. Additionally, the digital twin generator 180 generates the digital twin 186 based on a 3D point cloud from a LiDAR image to include depth information associated with the wall. The digital twin 186 is based on translated pixels from the collected images and the 3D point cloud that are generated to form one or more geometric representations of the wall. The digital twin 186 comprises a comprehensive digital model of the wall that includes information for deconstruction strategies, reuse and recycling of the materials associated with the wall, including wall dimensions, precise stud and screw locations, and parametric definitions for cutting areas.

The digital twin 186 can include an inventory of elements within or behind the wall, such as drywall or gypsum board, one or more drywall screws within the wall, one or more studs behind the wall, electrical fixtures within or behind the wall, or wiring within or behind the wall. The digital twin 186 represents the composition and the current physical state of the wall, including one or more locations of damage to the wall, if any. Damage to the wall can include water damage or cracks in the drywall or other elements of the wall. In some embodiments, the digital twin 186 generated by wall analysis application 170 comprises multiple layers and includes an outer layer generated from RGB images of the wall that includes the surface of the wall. The surface of the wall can include the exposed drywall, wood, composite, or other surface material. The surface material can be painted or stained in some embodiments. The digital twin 186 can also include a second layer that includes elements that are within or that pass through the wall, such as drywall screws, anchors, electrical fixtures, or other materials. The digital twin 186 can further include an inner layer that represents elements that are behind the wall, such as studs, support elements, wiring, plumbing, or any other building elements that can be installed or behind a wall. The digital twin 186 can also include an inventory of items that are associated with a wall along with the location or coordinates of the items. For example, the inventory can include a quantity and location of drywall screws, studs or support elements behind or within the wall, electrical fixtures, the location of cracks or water damage, or other items or aspects of the wall. In response to outputting the digital twin, examples of the disclosure can take one or more actions based on the digital twin, such as projecting a visual representation of the digital twin onto the wall that was analyzed using the image analysis.

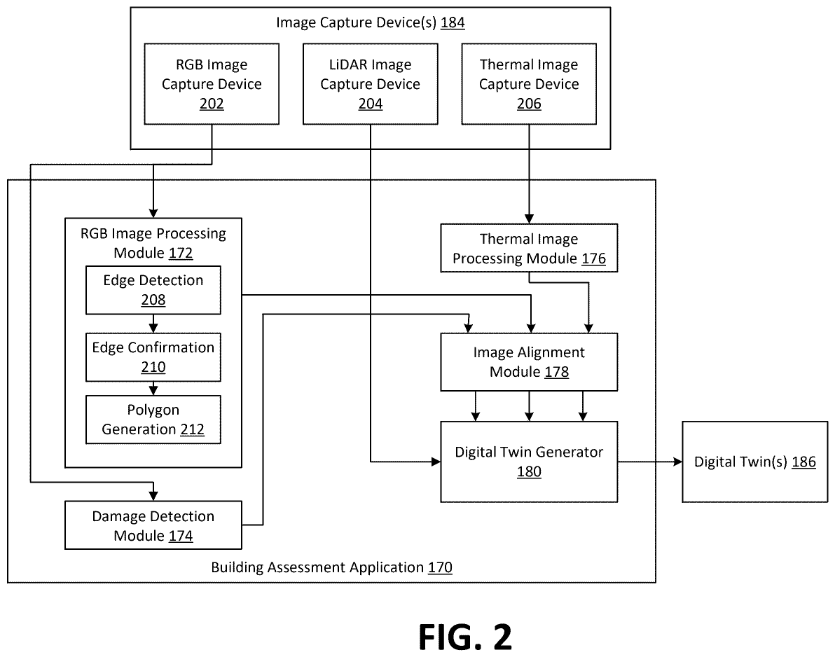

The image processing pipeline utilized by wall analysis application 170 for generating the digital twin 186 of the wall is described in more detail in the discussion of FIG. 2.

### Image Processing Pipeline

FIG. 2 is a more detailed illustration of the wall analysis application 170 of FIG. 1, according to various embodiments. As shown, the image capture devices 184 include, without limitation, an RGB image capture device 202, a LiDAR image capture device 204, and a thermal image capture device 206. In one embodiment, the image capture devices 184 are arranged in a common rig or device so that all the different image capture devices 184 are aimed at the same wall. In one implementation, the image capture devices 184 are coupled to a computing device that can initiate image capture and allow a user that is operating the rig to view, confirm, retake, or take other actions with respect to the images. Wall analysis application 170 receives or accesses images from the image capture devices 184. For example, the RGB image capture device 202 captures and provides one or more RGB images of a wall, the LiDAR image capture device 204 captures and provides a 3D point cloud of the wall, and the thermal image capture device 206 captures one or more thermal images of the wall. In one embodiment, the images are captured simultaneously with respect to each other. Image capture can be triggered by a user operating a rig associated with the image capture devices 184.

The RGB image processing module 172 receives one or more RGB images from RGB image capture device 202. RGB image processing module 172 performs one or more image processing operations to identify a wall shape corresponding to the wall for which images are captured by image capture devices 184. In the depicted example, RGB image processing module 172 invokes edge detection 208 to detect the edges of a wall in the RGB image provided to RGB image processing module 172. In one embodiment, a gradient of the image intensity at each pixel is calculated, and a steep gradient indicates or signals an edge. In some embodiments, a Hough transform is performed to account for gaps in an edge that might be caused by occlusions in the image. Edge detection 208 detects vertical and/or horizontal boundaries that define the wall, such as where the wall meets the floor or the ceiling in the RGB image. A filtering process, such as applying a Gaussian blur to the image, can smooth noise in the image to facilitate edge detection.

Edge detection 208 outputs an image with the edges corresponding to the wall identified in the image to edge confirmation 210. At edge confirmation 210, the user or an automated process confirms that the edges identified by edge detection 208 correspond to the shape of the wall. In one embodiment, a user interface can be presented to the user of a computing device associated with a rig containing image capture devices 184. Within the user interface, the edges identified by edge detection 208 are overlaid onto an image of the wall, which allows the user to confirm the edges or move or reshape the edges to reflect the shape of the wall. In some embodiments, an automated computer-vision process can confirm that the edges reflect the shape of the wall shown in the images from the image capture devices 184. Once the edges corresponding to the shape of the wall are confirmed, the edges are output to polygon generation 212. Polygon generation 212 outputs a polygon, such as a rectangular polygon, corresponding to the shape of the wall defined by the edges to image alignment module 178.

RGB image capture device 202 also outputs one or more RGB images to damage detection module 174. In one embodiment, an ML model is utilized by damage detection module 174 to classify areas of the wall represented in the RGB images as damaged. The ML model can be trained using a set of training data that includes images of walls having cracks, where the cracks are represented by high-frequency linear discontinuities. The training set can also include images of walls with water damage, which can be represented as color gradients corresponding to staining, blooming edges, peeling textures, or other indications of water damage. The ML model utilized by damage detection module 174 can output an annotated image that identifies the location of cracks or water damage, if any. The annotated image is output to image alignment module 178.

Thermal image capture device 206 outputs one or more thermal images of the wall to thermal image processing module 176. Thermal image processing module 176 processes the one or more thermal images to identify elements of the wall that are within or behind the wall. Thermal image processing module 176 outputs an annotated image to image alignment module 178 that identifies an inventory of items that are within or behind the wall along with respective locations of the items. Thermal image processing module 176 can also identify the boundaries of the drywall segments in the wall based on the thermal images by identifying seams between drywall segments or the location of drywall screws in the wall. In one embodiment, the thermal image processing module 176 receives multiple thermal images from a thermal camera, and the multiple thermal images are stitched together using an image stitching pipeline. The image stitching pipeline outputs a single thermal image of the wall from which the image alignment module 178 can generate the annotated thermal image that is output to image alignment module 178.

Image alignment module 178 receives the polygon from polygon generation 212, the annotated image resulting from the damage assessment performed by damage detection module 174, and the annotated thermal image from thermal image processing module 176. Image alignment module 178 processes the polygon and aligns the images. In one embodiment, image alignment module 178 performs an alignment process in which the polygon, the annotated image from damage detection module 174, and the annotated thermal image from thermal image processing module 176 are aligned using edge alignment and systematic minimization of lens distortion effects.

Digital twin generator 180 generates a digital twin 186 of the wall based on the aligned images from image alignment module 178, the inventory generated by thermal image processing module 176, the location of damage identified by damage detection module 174, and the polygon generated by RGB image processing module 172. Digital twin generator 180 also generates the digital twin 186 based on a 3D point cloud from a LiDAR image to include depth information associated with the wall. The digital twin 186 also includes an inventory of reusable and non-reusable elements associated with the wall. For example, based on the dimensions of the wall, digital twin generator 180 determines the amount or quantity of drywall in the wall. Digital twin generator 180 can also specify the location of drywall seams and drywall screws, which are specified in the digital twin 186. Digital twin generator 180 also specifies the location of light fixtures, wiring, plumbing, studs, or other elements associated with the wall.

The digital twin 186 can be utilized by wall analysis application 170 or another downstream application or process to determine the amount of reusable or recyclable materials in a wall. For example, wall analysis application 170 can determine the recycling value of the elements of the wall based on the inventory of reusable elements specified by the digital twin 186, such as the dimensions of drywall, a quantity of drywall screws, a quantity of wood in the studs behind the wall, and electrical fixtures. The wall analysis application 170 can also determine a cost to remove the inventory of reusable elements from the building interior based on the identified quantities. Because the digital twin 186 specifies the locations of drywall seams, drywall screws, studs, electrical fixtures, and other wall elements, the removal cost and removal procedure is also simplified because construction personnel can utilize the digital twin 186 to more efficiently deconstruct or remove the wall and elements of the wall from a building interior. Additionally, the digital twin 186 also includes the location of cracks or water damage to the wall, which represents portions of the wall that may not be reusable or recyclable.

### Damage Detection Module

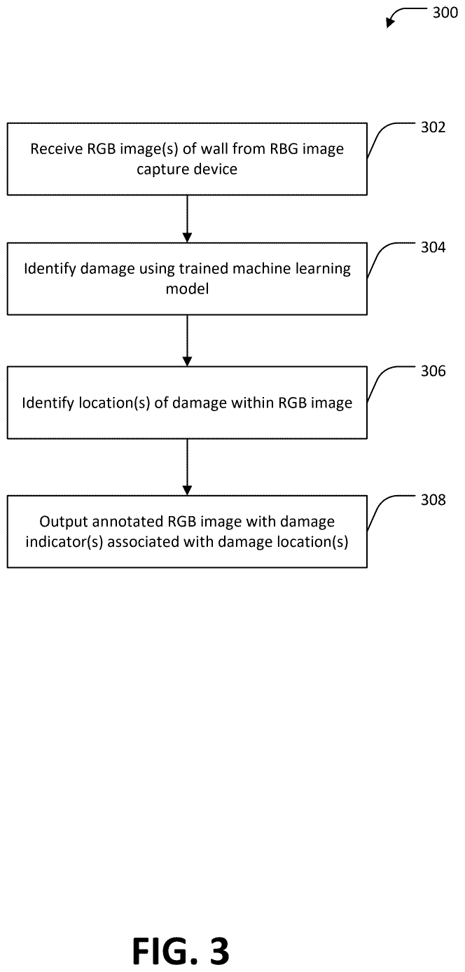

FIG. 3 is a flow diagram of method steps for conducting a damage assessment by damage detection module 174, according to various embodiments. Although the method steps are described in conjunction with the systems of FIGS. 1-2, persons skilled in the art will understand that any system configured to perform the method steps, in any order, is within the scope of the present invention.

As shown, a method 300 begins at step 302, where damage detection module 174 receives one or more RGB images of a wall. The RGB images can be captured by an RGB image capture device 202 associated with a rig including image capture devices 184, such as a LiDAR image capture device 204 and thermal image capture device 206, in addition to the RGB image capture device 202. In some embodiments, damage detection module 174 receives a greyscale image of the wall from which the damage assessment can be conducted.

At step 304, damage detection module 174 identifies damage to the wall using a trained ML model. In one embodiment, an ML model is utilized by damage detection module 174 to classify areas of the wall represented in the RGB images as damaged. In some embodiments, the ML model is trained to detect wall damage, such as cracks or water damage, in images of a wall. The ML model can comprise an object detection model that is trained using a training data set including labeled images in which water damage or cracks are labeled, and the labeled images serve as a ground-truth data set that is used to train the ML model to detect damage.

At step 306, damage detection module 174 identifies one or more locations of damage to the wall. The locations can be identified within the RGB image and expressed as coordinates in a coordinate system. In some embodiments, the locations of damage can be expressed as bounding boxes that are drawn around the identified damage locations and represented as bounding box coordinates. In another embodiment, the location of damage can be expressed by the location or identifiers of pixels in the image that are associated with damage.

At step 308, damage detection module 174 outputs an annotated image with damage indicators associated with the location of damage. The damage indicators indicate what type of damage has been identified by damage detection module 174, and the damage location identifies a location within the annotated image of the damage.

### Image Processing Module

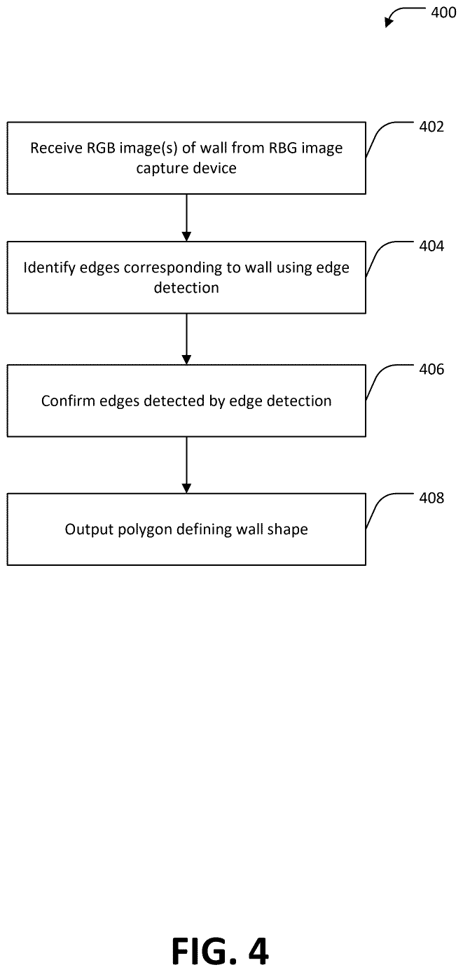

FIG. 4 is a flow diagram illustrating how RGB image processing module 172 generates a polygon corresponding to the shape of a wall, according to various embodiments. Although the method steps are described in conjunction with the systems of FIGS. 1-2, persons skilled in the art will understand that any system configured to perform the method steps, in any order, is within the scope of the present invention.

As shown, a method 400 begins at step 402, where damage detection module 174 receives one or more RGB images of a wall. The RGB images can be captured by an RGB image capture device 202 associated with a rig including image capture devices 184, such as a LiDAR image capture device 204 and thermal image capture device 206, in addition to the RGB image capture device 202. In some embodiments, the RGB image processing module 172 receives a greyscale image of the wall from which the damage assessment can be conducted.

At step 404, RGB image processing module 172 identifies edges corresponding to the wall using one or more edge detection techniques. The RGB image processing module 172 performs an analysis of one or more RGB images of the wall to identify the wall shape. In one embodiment, RGB image processing module 172 performs edge detection techniques or other computer vision or pixel processing techniques on an image of the wall to identify the outline or shape of the wall. In one embodiment, wall analysis application 170 performs geometric edge detection techniques, such as Canny edge detection, to identify the edges of the wall. In some embodiments, a House transform can be performed to find the wall shape. In other embodiments, deep learning techniques can be utilized to identify the wall shape based on one or more RGB images from the image capture devices 184. For example, a deep neural network can be used to generate one or more edge maps. In other embodiments, a convolutional neural network (CNN) or U-Net can be utilized that labels each pixel in an image as a portion of a building interior, such as “wall,” “floor”, “ceiling,” or “window,” and the labeled wall portions are extracted to form the wall shape.

At step 406, RGB image processing module 172 confirms the edges detected by the edge detection techniques. In other words, RGB image processing module 172 performs a wall confirming step in which a user or an automated process confirms that the edges identified by RGB image processing module 172 correspond to the shape of the wall. In one embodiment, a user interface can be presented to the user, overlaying the edges or the polygon onto an image of the wall, and the user interface allows the user to confirm that the edges reflect the shape of the wall. The user interface allows the user to edit or move the edges so that the edges align with the shape of the wall within the image. In some embodiments, an automated computer-vision process can confirm that the edges reflect the shape of the wall shown in the images from the image capture devices 184.

At step 408, RGB image processing module 172 outputs a polygon defining the wall shape. The RGB image processing module 172 can output the polygon to image alignment module 178 so that the polygon can be aligned with one or more other images of the wall in the process of generating the digital twin 186 of the wall.

### Thermal Image Processing Module

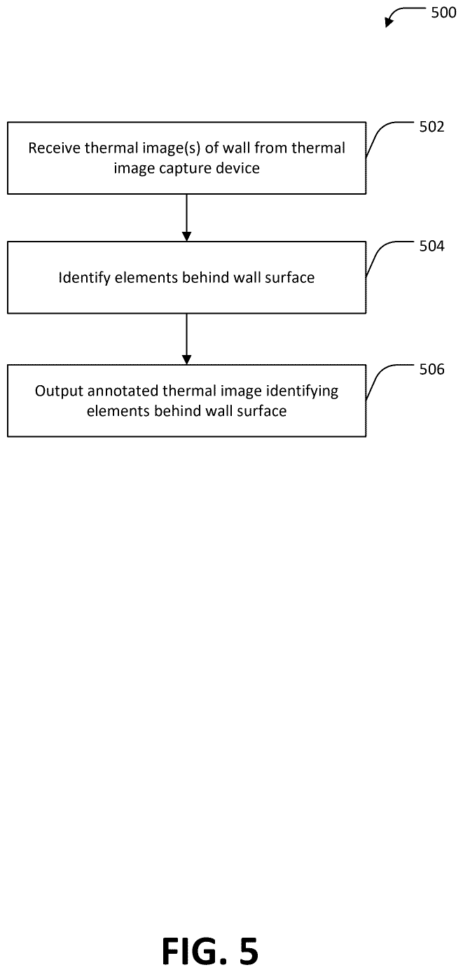

FIG. 5 is a flow diagram illustrating how thermal image processing module 176 identifies elements within or behind a wall, according to various embodiments. Although the method steps are described in conjunction with the systems of FIGS. 1-2, persons skilled in the art will understand that any system configured to perform the method steps, in any order, is within the scope of the present invention.

As shown, a method 500 begins at step 502, where thermal image processing module 176 receives one or more thermal images associated with a wall. The thermal images can be captured by a thermal image capture device 206 associated with a rig including image capture devices 184, such as a LiDAR image capture device 204 and RGB image capture device 202, in addition to the thermal image capture device 206. In some embodiments, the thermal image processing module 176 receives multiple thermal images associated with the wall that are stitched together to form a single composite thermal image of the wall by thermal image processing module 176.

At step 504, thermal image processing module 176 identifies elements of the wall that are within or behind the wall. Elements that are within or behind the wall can be associated with a different thermal signature than the drywall or other material that comprises the bulk of the wall. For example, drywall screws that are within the wall, studs that are behind the wall, and/or electrical fixtures or wiring can appear in a thermal image with varying levels of brightness, shapes, and contrast. Additionally, the thermal images can also indicate moisture content associated with the wall, and such moisture content can also be used to identify possible water damage.

At step 506, thermal image processing module 176 outputs an annotated image based on the thermal image. The annotated thermal image identifies an inventory of items that are within or behind the wall along with respective locations of the items. The annotated thermal image also identifies the location of items in the inventory of items.

### Digital Twin Generator

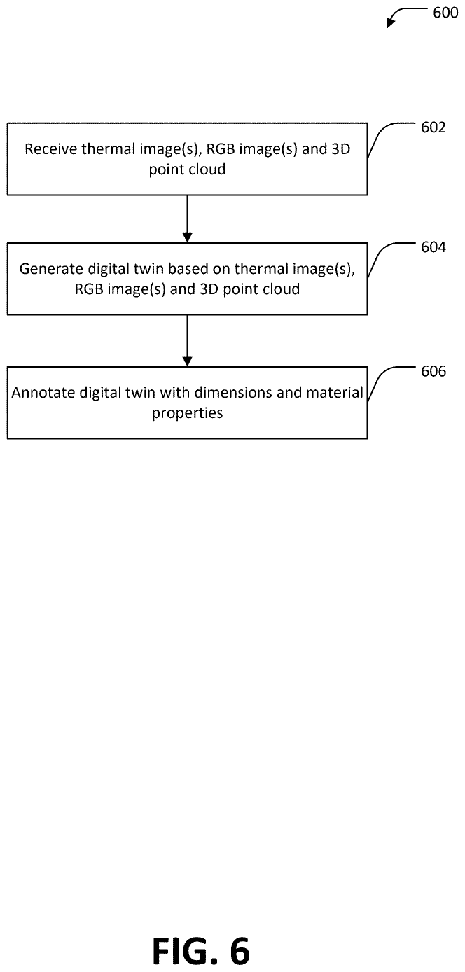

FIG. 6 is a flow diagram illustrating how the digital twin generator 180 identifies elements within or behind a wall, according to various embodiments. Although the method steps are described in conjunction with the systems of FIGS. 1-2, persons skilled in the art will understand that any system configured to perform the method steps, in any order, is within the scope of the present invention.

As shown, a method 600 begins at step 602, where digital twin generator 180 receives aligned thermal images and RGB images from image alignment module 178, as well as a 3D point cloud from LiDAR image capture device 204. The aligned thermal images and RGB images are also annotated with metadata identifying the location of damage as well as elements within or behind the wall, such as drywall screws, studs, drywall seams, wiring, electrical fixtures, etc.

At step 604, digital twin generator 180 generates a digital twin 186 of the wall based on the annotated images as well as the 3D point cloud from a LiDAR image to include depth information associated with the wall. The digital twin 186 is based on translated pixels from the collected images and the 3D point cloud that are generated to form one or more geometric representations of the wall. The digital twin 186 comprises a comprehensive digital model of the wall that includes information for deconstruction strategies, reuse and recycling of the materials associated with the wall, including wall dimensions, precise stud and screw locations, and parametric definitions for cutting areas.

At step 606, digital twin generator 180 annotates or enriches the digital twin 186 with dimensions and material properties associated with the wall. For example, the digital twin 186 can include an inventory of elements within or behind the wall, such as drywall or gypsum board, one or more drywall screws within the wall, one or more studs behind the wall, electrical fixtures within or behind the wall, or wiring within or behind the wall. The digital twin 186 represents the composition and the current physical state of the wall, including one or more locations of damage to the wall, if any. Damage to the wall can include water damage or cracks in the drywall or other elements of the wall. In some embodiments, the digital twin 186 generated by wall analysis application 170 comprises multiple layers and includes an outer layer generated from RGB images of the wall that includes the surface of the wall. The surface of the wall can include the exposed drywall, wood, composite, or other surface material. The surface material can be painted or stained in some embodiments. The digital twin 186 can also include a second layer that includes elements that are within or that pass through the wall, such as drywall screws, anchors, electrical fixtures, or other materials. The digital twin 186 can further include an inner layer that represents elements that are behind the wall, such as studs, support elements, wiring, plumbing, or any other building elements that can be installed or behind a wall. The digital twin 186 can also include an inventory of items that are associated with a wall along with the location or coordinates of the items.

### System Implementation

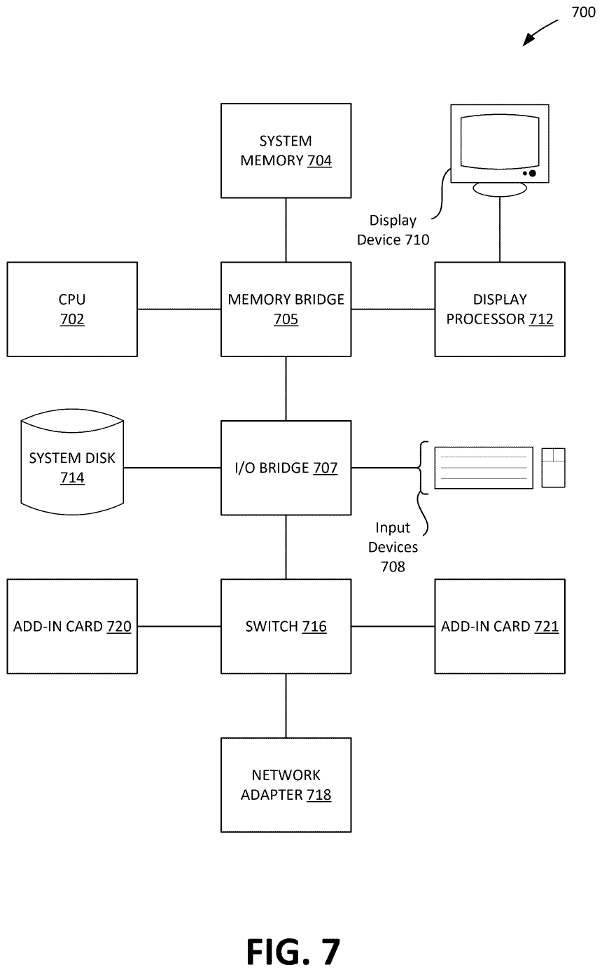

FIG. 7 is a more detailed illustration of a computing device that can implement the functionalities of the entities illustrated in FIG. 1, according to various embodiments. The computing device can represent computing device 160 and any other computing devices discussed throughout the disclosure (such as server devices with which the computing device 160 is communicably coupled. This figure in no way limits or is intended to limit the scope of the various embodiments. In various implementations, system 700 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 700 may be coupled together to practice one or more aspects of the various embodiments.

As shown, system 700 includes a central processing unit (CPU) 602 and a system memory 704 communicating via a bus path that may include a memory bridge 705. CPU 702 includes one or more processing cores, and, in operation, CPU 702 is the master processor of system 700, controlling and coordinating operations of other system components. System memory 704 stores software applications and data for use by CPU 702. CPU 702 runs software applications and optionally an operating system. Memory bridge 705, which may be, e.g., a Northbridge chip, is connected via a bus or other communication path (e.g., a HyperTransport link) to an I/O (input/output) bridge 707. I/O bridge 707, which may be, e.g., a Southbridge chip, receives user input from one or more user input devices 708 (e.g., keyboard, mouse, joystick, digitizer tablets, touch pads, touch screens, still or video cameras, motion sensors, and/or microphones) and forwards the input to CPU 702 via memory bridge 705.

A display processor 712 is coupled to memory bridge 705 via a bus or other communication path (e.g., a PCI Express, Accelerated Graphics Port, or HyperTransport link); in one embodiment display processor 712 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 704.

Display processor 712 periodically delivers pixels to a display device 710 (e.g., a screen or conventional CRT, plasma, OLED, SED or LCD based monitor or television). Additionally, display processor 712 may output pixels to film recorders adapted to reproduce computer generated images on photographic film. Display processor 712 can provide display device 710 with an analog or digital signal. In various embodiments, one or more of the various graphical user interfaces set forth in FIG. 3 are displayed to one or more users via display device 710, and the one or more users can input data into and receive visual output from those various graphical user interfaces.

A system disk 714 is also connected to I/O bridge 707 and may be configured to store content and applications and data for use by CPU 702 and display processor 712. System disk 714 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 716 provides connections between I/O bridge 707 and other components such as a network adapter 718 and various add-in cards 721. Network adapter 718 allows system 700 to communicate with other systems via an electronic communications network, and may include wired or wireless communication over local area networks and wide area networks such as the Internet.

Other components (not shown), including USB or other port connections, film recording devices, and the like, may also be connected to I/O bridge 707. For example, an audio processor may be used to generate analog or digital audio output from instructions and/or data provided by CPU 702, system memory 704, or system disk 714. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 712 incorporates circuitry optimized for graphics and video processing, including, for example, video output circuitry, and constitutes a graphics processing unit (GPU). In another embodiment, display processor 712 incorporates circuitry optimized for general purpose processing. In yet another embodiment, display processor 712 may be integrated with one or more other system elements, such as the memory bridge 705, CPU 702, and I/O bridge 707 to form a system on chip (SoC). In still further embodiments, display processor 712 is omitted and software executed by CPU 702 performs the functions of display processor 712.

Pixel data can be provided to display processor 712 directly from CPU 702. In some embodiments, instructions and/or data representing a scene are provided to a render farm or a set of server computers, each similar to system 700, via network adapter 718 or system disk 714. The render farm generates one or more rendered images of the scene using the provided instructions and/or data. These rendered images may be stored on computer-readable media in a digital format and optionally returned to system 700 for display. Similarly, stereo image pairs processed by display processor 712 may be output to other systems for display, stored in system disk 714, or stored on computer-readable media in a digital format.

Alternatively, CPU 702 provides display processor 712 with data and/or instructions defining the desired output images, from which display processor 712 generates the pixel data of one or more output images, including characterizing and/or adjusting the offset between stereo image pairs. The data and/or instructions defining the desired output images can be stored in system memory 704 or graphics memory within display processor 712. In an embodiment, display processor 712 includes 3D rendering capabilities for generating pixel data for output images from instructions and data defining the geometry, lighting shading, texturing, motion, and/or camera parameters for a scene. Display processor 712 can further include one or more programmable execution units capable of executing shader programs, tone mapping programs, and the like.

Further, in other embodiments, CPU 702 or display processor 712 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 702, display processor 712, or one or more other processing devices or any combination of these different processors.

CPU 702, render farm, and/or display processor 712 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 700 may be a robot or robotic device and may include CPU 702 and/or other processing units or devices and system memory 704. In such embodiments, system 700 may or may not include other elements shown in FIG. 6. System memory 704 and/or other memory units or devices in system 700 may include instructions that, when executed, cause the robot or robotic device represented by system 700 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 704 is connected to CPU 702 directly rather than through a bridge, and other devices communicate with system memory 704 via memory bridge 705 and CPU 702. In other alternative topologies display processor 712 is connected to I/O bridge 707 or directly to CPU 702, rather than to memory bridge 705. In still other embodiments, I/O bridge 707 and memory bridge 705 might be integrated into a single chip. The particular components shown herein are optional; for instance, any number of add-in cards or peripheral devices might be supported. In some embodiments, switch 716 is eliminated, and network adapter 718 and add-in cards 720, 721 connect directly to I/O bridge 707.

In sum, the disclosed techniques include capturing RGB images and thermal images of a wall. Image processing techniques are implemented to generate, based on the RGB images and the thermal images, a polygon that corresponds to a wall shape. For example, edge detection operations are utilized to identify the boundaries of the wall to output the polygon. Additionally, image processing techniques are implemented to identify elements within or behind the wall based on RGB images and the thermal images. The RGB and thermal images are aligned based on the generated polygon of the wall. An inventory of elements within or behind the wall is also generated based on the RGB images and the thermal images. Based on the inventory and aligned RGB images and the thermal images, a digital twin that corresponds to the wall is generated, where the digital twin can be used to guide reuse or recycling of elements within or behind the wall.

At least one technical advantage of the disclosed techniques relative to the prior art is that the disclosed techniques enable building material audits to be performed using contactless and non-destructive techniques that involve imaging devices such as a red/green/blue (RGB) imaging device and/or a thermal imaging device. Walls within an interior of a building can be imaged using an imaging device, and a composition of the materials used to construct the building can be assessed based on imagery captured from the interior of the building. Images captured by imaging devices can then be assessed using image processing techniques to determine the material composition of the structure of the building. Additionally, a location of elements used in the composition of the building can be used to streamline the process of removing and recycling material such as drywall or gypsum board, as well as structural elements, from the building. Therefore, a building material audit can be performed in a nondestructive and noninvasive manner, while also streamlining the process of material removal and recycling. The disclosed techniques also offer building designers data about material reuse that streamline existing building design.

These technical advantages provide one or more technological advancements over prior art approaches.

1. In some embodiments, a computer-implemented method for analyzing walls based on images of the walls to generate a digital representation of the walls comprises receiving a plurality of images of a wall of a building interior, performing a damage assessment of the wall using a machine learning (ML) model based on the plurality of images, identifying a plurality of edges of the wall based on the plurality of images, identifying one or more elements within or behind the wall based on the plurality of images, generating a digital twin corresponding to the wall based on the damage assessment, the plurality of edges, and the one or more elements, and performing at least one action based on the digital twin.

2. The computer-implemented method of clause 1, wherein generating the digital twin comprises generating an inventory of reusable elements associated with the wall.

3. The computer-implemented method of clauses 1 or 2, wherein the inventory of reusable elements comprises at least one of a quantity of screws, an amount of gypsum board based on dimensions of the wall, or a quantity of studs behind the wall.

4. The computer-implemented method of any of clauses 1-3, further comprising determining a recycling cost based on the inventory of reusable elements and a removal cost of the inventory of reusable elements from the building interior.

5. The computer-implemented method of any of clauses 1-4, wherein the ML model comprises an object detection model, and wherein the damage assessment comprises determining whether the plurality of images indicate that the wall includes at least one of water damage or at least one crack.

6. The computer-implemented method of any of clauses 1-5, wherein the damage assessment further comprises at least one of determining respective dimensions of the water damage or the at least one crack and outputting an annotated image with the respective dimensions.

7. The computer-implemented method of any of clauses 1-6, further comprising training the ML model based on a plurality of ground truth images associated with respective damaged walls and undamaged walls.

8. The computer-implemented method of any of clauses 1-7, wherein the damage assessment is performed and the edges are identified based on at least one RGB image from the plurality of images.

9. The computer-implemented method of any of clauses 1-8, wherein identifying the plurality of edges of the wall based on the plurality of images is based on one or more edge detection operations that generate a polygon corresponding to a shape of the wall.

10. The computer-implemented method of any of clauses 1-9, wherein the one or more edge detection techniques further comprises receiving a confirmation that the polygon corresponds to the shape of the wall, wherein the digital twin comprises the polygon.

11. The computer-implemented method of any of clauses 1-10, further comprising aligning the plurality of images based on the polygon to generate a plurality of aligned images, wherein the digital twin comprises the plurality of aligned images.

12. The computer-implemented method of any of clauses 1-11, wherein the at least one action comprises projecting a visual representation of the digital twin onto the wall.

13. In some embodiments, one or more non-transitory computer-readable media include instructions that, when executed by one or more processors, cause the one or more processors to analyze walls based on images of the walls to generate a digital representation of the walls, by performing the steps of receiving a plurality of images of a wall of a building interior, performing a damage assessment of the wall using a machine learning (ML) model based on the plurality of images, identifying a plurality of edges of the wall based on the plurality of images, identifying one or more elements within or behind the wall based on the plurality of images, generating a digital twin corresponding to the wall based on the damage assessment, the plurality of edges, and the one or more elements, and performing at least one action based on the digital twin.

14. The one or more non-transitory computer-readable media of clause 13, wherein identifying one or more elements within or behind the wall based on the plurality of images comprises receiving at least one thermal image of the wall, and identifying at least one of a stud or a screw within or behind the wall based on the at least one thermal image.

15. The one or more non-transitory computer-readable media of clauses 13 or 14, further comprising generating an annotated output image based on the at least one thermal image of the wall, wherein the annotated output image identifies a respective location of the at least of the stud or the screw within or behind the wall.

16. The one or more non-transitory computer-readable media of any of clauses 13-15, wherein the digital twin comprises an inventory including the at least one of the stud or the screw.

17. The one or more non-transitory computer-readable media of any of clauses 13-16, wherein generating the digital twin comprises generating an inventory of reusable elements associated with the wall.

18. The one or more non-transitory computer-readable media of any of clauses 13-17, wherein the ML model comprises an object detection model and wherein the damage assessment comprises determining whether the plurality of images indicate that the wall includes at least one of water damage or at least one crack.

19. The one or more non-transitory computer-readable media of any of clauses 13-18, wherein identifying the plurality of edges of the wall based on the plurality of images is based on one or more edge detection operations that generate a polygon corresponding to a shape of the wall, and the steps further comprise aligning the plurality of images based on the polygon to generate a plurality of aligned images, wherein the digital twin comprises the plurality of aligned images.

20. In some embodiments, a system comprises one or more memories storing instructions, and one or more processors coupled to the one or more memories that, when executed, analyze walls based on images of the walls to generate a digital representation of the walls, by performing the steps of receiving a plurality of images of a wall of a building interior, performing a damage assessment of the wall using a machine learning (ML) model based on the plurality of images, identifying a plurality of edges of the wall based on the plurality of images, identifying one or more elements within or behind the wall based on the plurality of images, generating a digital twin corresponding to the wall based on the damage assessment, the plurality of edges, and the one or more elements, and performing at least one action based on the digital twin.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for analyzing walls based on images of the walls to generate a digital representation of the walls, the method comprising:
receiving a plurality of images of a wall of a building interior;
performing a damage assessment of the wall using a machine learning (ML) model based on the plurality of images;
identifying a plurality of edges of the wall based on the plurality of images;
identifying one or more elements within or behind the wall based on the plurality of images;
generating a digital twin corresponding to the wall based on the damage assessment, the plurality of edges, and the one or more elements; and
performing at least one action based on the digital twin.

2. The computer-implemented method of claim 1, wherein generating the digital twin comprises generating an inventory of reusable elements associated with the wall.

3. The computer-implemented method of claim 2, wherein the inventory of reusable elements comprises at least one of a quantity of screws, an amount of gypsum board based on dimensions of the wall, or a quantity of studs behind the wall.

4. The computer-implemented method of claim 3, further comprising determining a recycling cost based on the inventory of reusable elements and a removal cost of the inventory of reusable elements from the building interior.

5. The computer-implemented method of claim 1, wherein the ML model comprises an object detection model, and wherein the damage assessment comprises determining whether the plurality of images indicate that the wall includes at least one of water damage or at least one crack.

6. The computer-implemented method of claim 5, wherein the damage assessment further comprises at least one of determining respective dimensions of the water damage or the at least one crack and outputting an annotated image with the respective dimensions.

7. The computer-implemented method of claim 1, further comprising training the ML model based on a plurality of ground truth images associated with respective damaged walls and undamaged walls.

8. The computer-implemented method of claim 1, wherein the damage assessment is performed and the edges are identified based on at least one RGB image from the plurality of images.

9. The computer-implemented method of claim 1, wherein identifying the plurality of edges of the wall based on the plurality of images is based on one or more edge detection operations that generate a polygon corresponding to a shape of the wall.

10. The computer-implemented method of claim 9, wherein the one or more edge detection techniques further comprises receiving a confirmation that the polygon corresponds to the shape of the wall, wherein the digital twin comprises the polygon.

11. The computer-implemented method of claim 9, further comprising aligning the plurality of images based on the polygon to generate a plurality of aligned images, wherein the digital twin comprises the plurality of aligned images.

12. The computer-implemented method of claim 1, wherein the at least one action comprises projecting a visual representation of the digital twin onto the wall.

13. One or more non-transitory computer-readable media including instructions that, when executed by one or more processors, cause the one or more processors to analyze walls based on images of the walls to generate a digital representation of the walls, by performing the steps of:
receiving a plurality of images of a wall of a building interior;
performing a damage assessment of the wall using a machine learning (ML) model based on the plurality of images;
identifying a plurality of edges of the wall based on the plurality of images;
identifying one or more elements within or behind the wall based on the plurality of images;
generating a digital twin corresponding to the wall based on the damage assessment, the plurality of edges, and the one or more elements; and
performing at least one action based on the digital twin.

14. The one or more non-transitory computer-readable media of claim 13, wherein identifying one or more elements within or behind the wall based on the plurality of images comprises:
receiving at least one thermal image of the wall; and
identifying at least one of a stud or a screw within or behind the wall based on the at least one thermal image.

15. The one or more non-transitory computer-readable media of claim 14, further comprising generating an annotated output image based on the at least one thermal image of the wall, wherein the annotated output image identifies a respective location of the at least of the stud or the screw within or behind the wall.

16. The one or more non-transitory computer-readable media of claim 14, wherein the digital twin comprises an inventory including the at least one of the stud or the screw.

17. The one or more non-transitory computer-readable media of claim 13, wherein generating the digital twin comprises generating an inventory of reusable elements associated with the wall.

18. The one or more non-transitory computer-readable media of claim 13, wherein the ML model comprises an object detection model and wherein the damage assessment comprises determining whether the plurality of images indicate that the wall includes at least one of water damage or at least one crack.

19. The one or more non-transitory computer-readable media of claim 13, wherein identifying the plurality of edges of the wall based on the plurality of images is based on one or more edge detection operations that generate a polygon corresponding to a shape of the wall, and the steps further comprise aligning the plurality of images based on the polygon to generate a plurality of aligned images, wherein the digital twin comprises the plurality of aligned images.

20. A system, comprising:
one or more memories storing instructions; and
one or more processors coupled to the one or more memories that, when executed, analyze walls based on images of the walls to generate a digital representation of the walls, by performing the steps of:
receiving a plurality of images of a wall of a building interior;
performing a damage assessment of the wall using a machine learning (ML) model based on the plurality of images;
identifying a plurality of edges of the wall based on the plurality of images;
identifying one or more elements within or behind the wall based on the plurality of images;
generating a digital twin corresponding to the wall based on the damage assessment, the plurality of edges, and the one or more elements; and
performing at least one action based on the digital twin.
